(19) United States
(12) Patent Application Publication
(10) Pub. No.: US 2006/0116154 A1
(43) Pub. Date: Jun. 1, 2006

(54) Transmission power control of a base station in a mobile communication system

(75) Inventor: Kyoo-Jin Han, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG-Nortel Co., Ltd.

(21) Appl. No.: 11/292,219

(22) Filed: Nov. 30, 2005

(30) Foreign Application Priority Data
Dec. 1, 2004 (KR) 10-2004-0099851

(51) Int. Cl. H04B 7/00

(52) U.S. Cl. 455/522; 455/561

(57) ABSTRACT

A transmission power control apparatus in a mobile communication system comprises a base station manager adapted to control transmission power of base station channels, wherein the base station manager comprises a channel gain setting unit adapted to set a channel gain ration for each of a plurality of base station channels, the channel gain ratio being a ratio of transmission power of a base station channel to maximum transmission power of a base station, the base station manager further comprising a channel gain converting unit adapted to calculate a power value for each of the plurality of base station channels based on the corresponding channel gain ratio and to transmit the calculated power value to the base station. The transmission power control apparatus further comprises the base station adapted to control the transmission power of each of the plurality of base station channels based on the calculated power values.

### CROSS-REFERENCE TO RELATED APPLICATIONS

Pursuant to 35 U.S.C. § 119(a), this application claims the benefit of earlier filing date and right of priority to Korean Application No. 2004-0099851, filed on Dec. 1, 2004, the contents of which are hereby incorporated by reference herein in their entirety.

### FIELD OF THE INVENTION

The present invention relates generally to a mobile communication system and, more particularly, to transmission power control of a base station in a mobile communication system.

### BACKGROUND OF THE INVENTION

A mobile communication system allows a user to wirelessly communicate with another party while traveling in a service area managed by a base station (BS) via controlling of switching by a mobile switching center (MSC). Such communications include voice and multimedia.

FIG. 1 is a block diagram illustrating a construction of a mobile communication system.

Referring to FIG. 1, the mobile communication system includes a mobile station (MS) 100 to receive a mobile communication service, a base station (BS) 200 wirelessly connected to the MS 100, a mobile switching center (MSC) 300 for switching the BS 200 to a BS where the MS 100 belongs, and a BSM (Base Station Manager) 400 for controlling transmission power of the BS 200. The BSM 400 controls transmission power of each channel of the BS 200 through a channel gain of the BS 200, a sector gain and an RF (Radio Frequency) gain.

FIG. 2 is a diagram illustrating an apparatus for controlling transmission power of a base station in a mobile communication system, in accordance with the related art. The apparatus includes the BSM 400 and the BS 200.

Referring to FIG. 2, the BSM 400 includes a channel gain setting unit 430 for setting a channel gain of a plurality of channels of the BS 200, a sector gain setting unit 420 for setting a sector gain of the BS 200, and an RF gain setting unit 410 for setting an RF gain of the BS 200. The plurality of channels include an overhead channel such as a pilot channel, a sync channel, and/or a paging channel, as well as a traffic channel.

The BS 200 includes a channel gain controlling unit 210 for controlling channel gains of a plurality of channels, a first adding unit 220 for adding transmission signals whose channel gains have been controlled, a second adding unit 230 for adding the added transmission signals and a transmission signal of the packet data channel, a sector gain controlling unit 240 for controlling a sector gain of the added transmission signals, an up-converter 250 for up-converting the sector gain-controlled transmission signals, an RF gain controlling unit 260 for controlling an RF gain of the up-converted transmission signals, and a front end unit 270 for transmitting the RF gain-controlled transmission signals through an antenna.

Referring to FIG. 2, a method for controlling transmission power of the base station is described below. A channel gain setting unit 430 sets channel gains of the plurality of channels. That is, transmission power of the overhead channels (e.g., the pilot channel), the sync channel and the paging channel are set by an operator to maintain a certain ratio with respect to maximum transmission power of the base station, but transmission power of the traffic channel is dynamically set by controlling forward power. A sector gain setting unit 420 sets a sector gain in a range of 0˜4095, and the RF gain setting unit 410 sets an RF gain in a range of 0˜3500. The BSM 400 transmits the set channel gain, sector gain and RF gain to the base station, such that the base station 200 may control transmission power within the maximum transmission power range based on the received channel gain, sector gain and the RF gain.

The transmission power of the packet data channel refers to transmission power obtained by subtracting the total of transmission power of the pilot channel, the sync channel, the paging channel and the traffic channel from the maximum transmission power of the base station. The transmission power of each channel of the base station in the mobile communication system will now be described with reference to FIG. 3.

FIG. 3 is a graph illustrating transmission power of each channel of a base station, in accordance with the related art.

Referring to FIG. 3, transmission power of the base station includes transmission power of overhead channels which is uniform with respect to the maximum transmission power of the base station, transmission power of traffic channels which varies according to the circumstances, and transmission power of the packet data channel which varies according to the transmission power of the overhead channel and the traffic channel.

However, controlling transmission power of the base station in the mobile communication system in accordance with the related art is problematic. Transmission power of each channel of the base station is controlled by controlling channel gains of the plurality of channels of the base station previously set by the operator. Thus, since the channel gains of the plurality of channels are individually controlled each time according to a change in the radio environment, the transmission power of the base station is not effectively controlled.

### SUMMARY OF THE INVENTION

Accordingly, the present invention is directed to transmission power control of a base station in a mobile communication system that substantially obviates one or more problems due to limitations and disadvantages of the related art.

An object of the present invention is to provide transmission power control of a base station in a mobile communication system such that a ratio of transmission power of a pilot channel to maximum transmission power of a base station is set and offset values for determining each transmission power of remaining channels with respect to the transmission power of the pilot channel are set to thereby effectively control transmission power of each channel of the base station.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a transmission power control apparatus in a mobile communication system comprises a base station manager adapted to control transmission power of base station channels, wherein the base station manager comprises a channel gain setting unit adapted to set a channel gain ratio for each of a plurality of base station channels, the channel gain ratio being a ratio of transmission power of a base station channel to maximum transmission power of a base station, the base station manager further comprising a channel gain converting unit adapted to calculate a power value for each of the plurality of base station channels based on the corresponding channel gain ratio and to transmit the calculated power value to the base station. The transmission power control apparatus further comprises the base station adapted to control the transmission power of each of the plurality of base station channels based on the calculated power values.

A first channel gain ratio may be set, the first channel gain ratio being a ratio of the transmission power of a pilot channel to the maximum transmission power of the base station, and offset values for determining transmission powers of remaining channels of the plurality of base station channels may be set in relationship to the transmission power of the pilot channel by the base station manager. The offset values for determining the transmission powers of the remaining channels may be used to control the transmission powers of the remaining channels by the base station manager.

The plurality of base station channels may comprise a sync channel, a paging channel, and a traffic channel. The pilot channel, the sync channel and the paging channel may be overhead channels.

The base station manager may further comprise a sector gain setting unit adapted to set a sector gain of the base station and to transmit the set sector gain to the base station, and an RF gain setting unit adapted to set an RF gain of the base station and to transmit the set RF gain to the base station.

The channel gain setting unit may set an offset value for determining transmission power of the sync channel in relationship to the transmission power of the pilot channel. The channel gain setting unit may set an offset value for determining transmission power of the paging channel in relationship to the transmission power of the pilot channel. The channel gain setting unit may set an offset value for determining transmission power of the traffic channel in relationship to the transmission power of the pilot channel.

In another embodiment, a method for controlling transmission power of a base station in a mobile communication system comprises setting a channel gain ratio, the channel gain ratio being a ratio of transmission power of a base station channel to maximum transmission power of the base station. The method also comprises calculating power values for each of a plurality of base station channels based on the corresponding channel gain ratios. The method also comprises transmitting the calculated power values to the base station for control of the transmission power of the plurality of base station channels.

The method may further comprise setting a first channel gain ratio, the first channel gain ratio being a ratio of the transmission power of a pilot channel to the maximum transmission power of the base station, setting offset values for determining transmission powers of remaining channels of the base station channels in relationship to the transmission power of the pilot channel, and controlling the transmission powers of the remaining channels using the offset values. The method may further comprise setting a sector gain of the base station, transmitting the set sector gain to the base station, setting an RF gain of the base station, and transmitting the set RF gain to the base station.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a block diagram illustrating a construction of a mobile communication system.

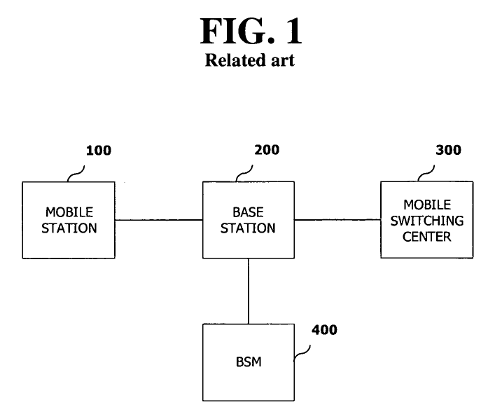

FIG. 2 is a diagram illustrating an apparatus for controlling transmission power of a base station in a mobile communication system, in accordance with the related art.

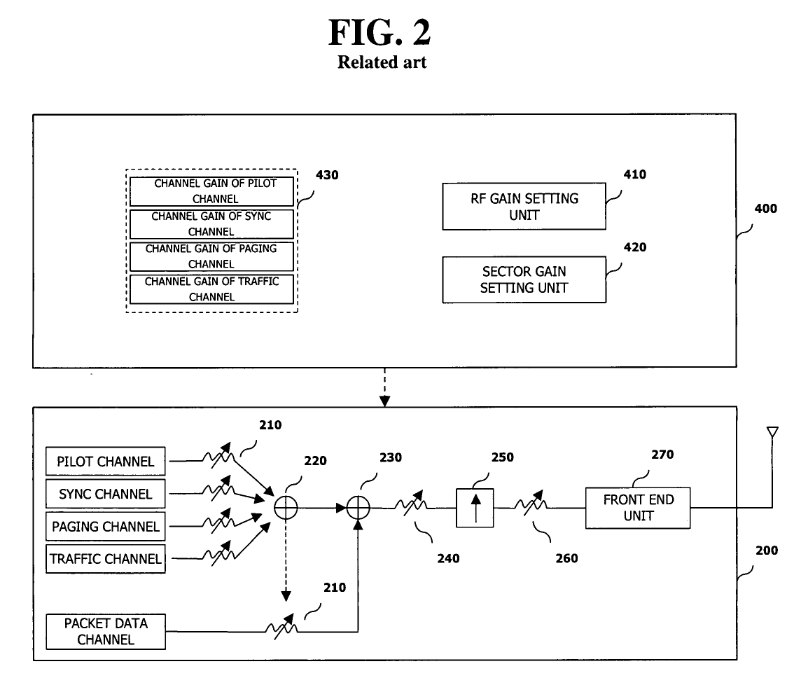

FIG. 3 is a graph illustrating transmission power of each channel of a base station, in accordance with the related art.

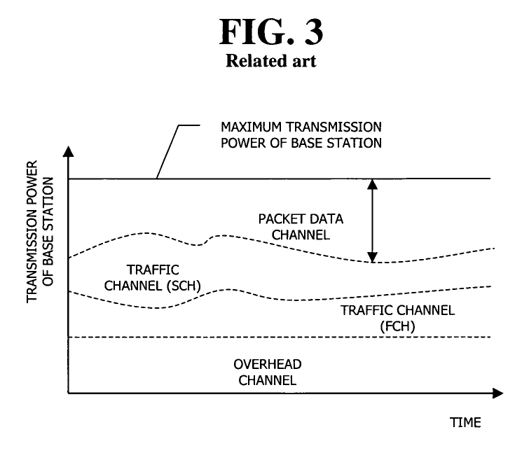

FIG. 4 is a diagram illustrating an apparatus for controlling transmission power of a base station in a mobile communication system, according to an embodiment of the present invention.

FIG. 5 is a flow diagram illustrating a method for controlling transmission power of a base station, according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Transmission power control of a base station in a mobile communication system such that a ratio of transmission power of a pilot channel to maximum transmission power of a base station is set and offset values of each transmission power of other remaining channels with respect to the transmission power of the pilot channel are determined to thereby effectively control transmission power of each channel of the base station is described below.

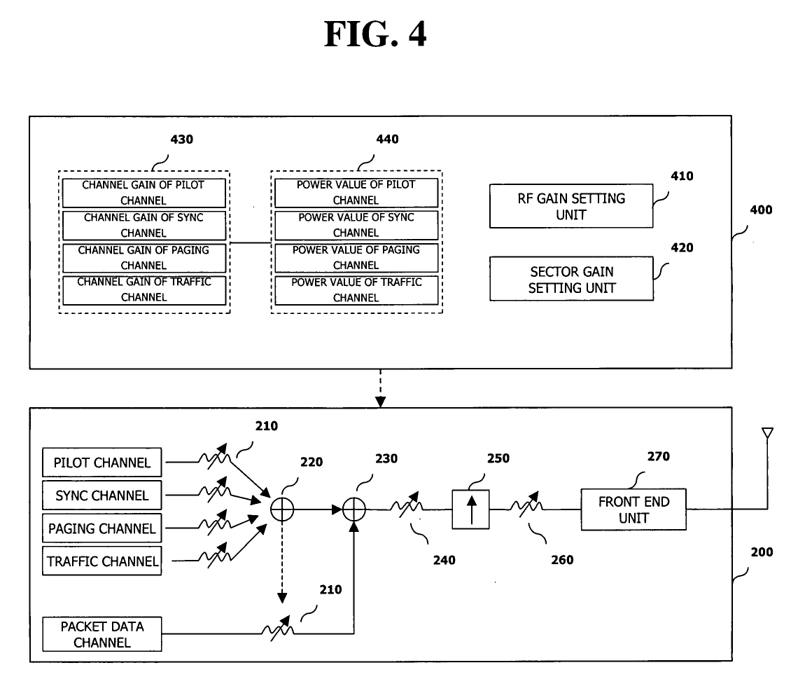

FIG. 4 is a diagram illustrating an apparatus for controlling transmission power of a base station in a mobile communication system, according to an embodiment of the present invention. The apparatus includes a base station manager (BSM) 450 and a base station (BS) 200.

Referring to FIG. 4, the BSM 450 includes a channel gain setting unit 430 for setting each channel gain of a plurality of channels of a base station, a channel gain converting unit 440 for converting the set channel gains into power values, a sector gain setting unit 420 for setting a sector gain of the base station, and an RF gain setting unit 410 for setting an RF gain of the base station. The plurality of channels may include overhead channels such as a pilot channel, a sync channel, and/or a paging channel, as well as a traffic channel.

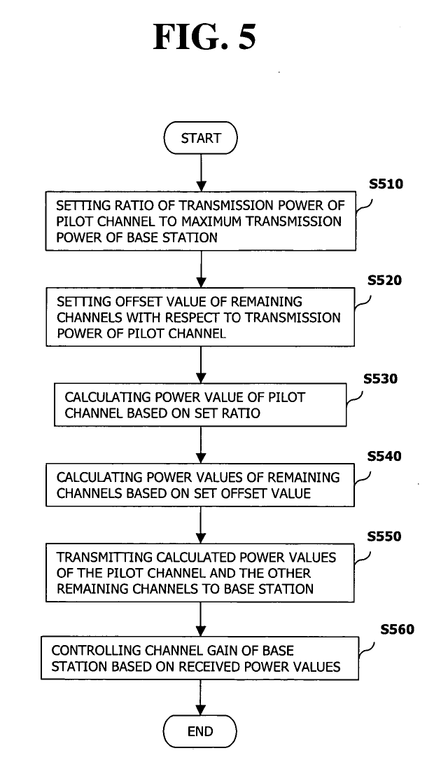

FIG. 5 is a flow diagram illustrating a method for controlling transmission power of a base station, according to an embodiment of the present invention.

Referring to FIG. 5, the method includes setting a ratio of transmission power of the pilot channel to maximum transmission power of the base station as a channel gain (S510), setting offset values of remaining channels to the set transmission power of the pilot channel as a channel gain (S520), calculating a power value of the pilot channel based on the set ratio (S530), calculating a power value of the other remaining channels based on the calculated power value of the pilot channel and the set offset values (S540), transmitting the calculated power value of the pilot channel and the power values of the other remaining channels to the base station (S550), and controlling a channel gain of the base station based on the received power values (S560).

Referring to FIGS. 4 and 5, the method for controlling transmission power of the base station is described in detail below. The channel gain setting unit 430 sets each channel gain of the plurality of channels. That is, the channel gain setting unit 430 sets transmission power of the overhead channels (e.g., the pilot channel), the sync channel and the paging channel through an operator to maintain a certain ratio with respect to the maximum transmission power of the base station, but sets transmission power of the traffic channel by controlling forward power.

The channel gain setting unit 430 sets each channel gain of the plurality of channels. The channel gain of the pilot channel is set as a ratio of transmission power of the pilot channel to the maximum transmission power of the base station (S510), while the channel gains of the sync channel, the paging channel and the traffic channel are set as offset values with respect to the set transmission power of the pilot channel (S520).

The channel gain setting unit 430 outputs the set channel gains to the channel gain converting unit 440, and the channel gain converting unit 440 calculates power values for each of the channels (S530, S540) based on the inputted channel gains and transmits the calculated power values to a channel gain controlling unit of the base station.

For example, a channel gain of the pilot channel may be set as 20% and a channel gain of the sync channel may be set as −18.75 dB. That is, when the ratio of transmission power of the pilot channel to the maximum transmission power of the base station is 20, the channel gain converting unit 440 calculates a power value of the pilot channel by equation (1) shown below, for example (S530):
Digital gain value of pilot channel=10*log10(0.2)=−7 dB (1)

If the offset value of the sync channel with respect to transmission power of the pilot channel is −18.75 dB, the channel gain converting unit 440 calculates a power value of the sync channel by equation (2) shown below, for example (S540):
Digital gain value of sync channel=power value of pilot channel+offset value of sync channel=(−7 dB)+(−18.75 dB)=−25.75 dB (2)

The channel gain converting unit 440 may calculate power values based on the channel gains of the pilot channel, the sync channel, the paging channel and the traffic channel by using equation (1) and equation (2).

The channel gain setting unit 430 sets the channel gains of the sync channel, the paging channel and the traffic channel as an offset value with respect to the pilot channel, such that when the channel gain of the pilot channel is changed according to a radio environment, the channel gains of the sync channel, the paging channel and the traffic channel may be automatically controlled based on the channel gain of the changed pilot channel without controlling by the operator.

The sector gain setting unit 420 sets the sector gain in the range of 0˜4095, and the RF gain setting unit 410 sets the RF gain in the range of 0˜3500. The BSM 400 transmits the set channel gain, the sector gain and the RF gain to the base station (S550). Then, the base station 200 may control transmission power within the maximum transmission power range based on the received channel gain, the sector gain and the RF gain (S560).

A channel gain controller 210 controls the channel gains of the plurality of channels based on the received power values, and a first adding unit 220 adds transmission signals whose channel gains have been controlled and outputs the added transmission signal.

The transmission power of the packet data channel refers to transmission power remaining by excluding the total of transmission power of the pilot channel, the sync channel, the paging channel and the traffic channel from the maximum transmission power of the base station, such that the channel gain controlling unit 210 may control the channel gain of the packet data channel based on the channel gains of the pilot channel, the sync channel, the paging channel and the traffic channel.

The second adding unit 230 adds the outputted transmission signal and a transmission signal that the channel gain of the packet data channel has controlled, and outputs the added transmission signal. The sector gain controlling unit 240 controls a sector gain of the outputted transmission signal based on the set sector gain and outputs the sector gain-controlled transmission signal. Thereafter, the up-converter 250 up-converts the outputted transmission signal into an IF (Intermediate Frequency) signal. Consequently, the RF gain controlling unit 260 controls an RF gain of the up-converted transmission signal based on the set RF gain and outputs the RF gain-controlled transmission signal. The front-end unit 270 then transmits the outputted transmission signal to the mobile terminal through the antenna.

In one embodiment, a transmission power control apparatus in a mobile communication system comprises a base station manager adapted to control transmission power of base station channels, wherein the base station manager comprises a channel gain setting unit adapted to set a channel gain ratio for each of a plurality of base station channels, the channel gain ratio being a ratio of transmission power of a base station channel to maximum transmission power of a base station, the base station manager further comprising a channel gain converting unit adapted to calculate a power value for each of the plurality of base station channels based on the corresponding channel gain ratio and to transmit the calculated power value to the base station. The transmission power control apparatus further comprises the base station adapted to control the transmission power of each of the plurality of base station channels based on the calculated power values.

A first channel gain ratio may be set, the first channel gain ratio being a ratio of the transmission power of a pilot channel to the maximum transmission power of the base station, and offset values for determining transmission powers of remaining channels of the plurality of base station channels may be set in relationship to the transmission power of the pilot channel by the base station manager. The offset values for determining the transmission powers of the remaining channels may be used to control the transmission powers of the remaining channels by the base station manager.

The plurality of base station channels may comprise a sync channel, a paging channel, and a traffic channel. The pilot channel, the sync channel and the paging channel may be overhead channels.

The base station manager may further comprise a sector gain setting unit adapted to set a sector gain of the base station and to transmit the set sector gain to the base station, and an RF gain setting unit adapted to set an RF gain of the base station and to transmit the set RF gain to the base station.

The channel gain setting unit may set an offset value for determining transmission power of the sync channel in relationship to the transmission power of the pilot channel. The channel gain setting unit may set an offset value for determining transmission power of the paging channel in relationship to the transmission power of the pilot channel. The channel gain setting unit may set an offset value for determining transmission power of the traffic channel in relationship to the transmission power of the pilot channel.

In another embodiment, a method for controlling transmission power of a base station in a mobile communication system comprises setting a channel gain ratio, the channel gain ratio being a ratio of transmission power of a base station channel to maximum transmission power of the base station. The method also comprises calculating power values for each of a plurality of base station channels based on the corresponding channel gain ratios. The method also comprises transmitting the calculated power values to the base station for control of the transmission power of the plurality of base station channels.

The method may further comprise setting a first channel gain ratio, the first channel gain ratio being a ratio of the transmission power of a pilot channel to the maximum transmission power of the base station, setting offset values for determining transmission powers of remaining channels of the base station channels in relationship to the transmission power of the pilot channel, and controlling the transmission powers of the remaining channels using the offset values. The method may further comprise setting a sector gain of the base station, transmitting the set sector gain to the base station, setting an RF gain of the base station, and transmitting the set RF gain to the base station.

The present invention provides for transmission power control of a base station in a mobile communication system, such that a ratio of the transmission power of the pilot channel to the maximum transmission power of the base station is set and offset values for determining each transmission power of the remaining channels with respect to the transmission power of the pilot channel are also set. Transmission power of each channel of the base station may thereby be effectively controlled.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A transmission power control apparatus in a mobile communication system, the transmission power control apparatus comprising:
a base station manager adapted to control transmission power of base station channels, wherein the base station manager comprises a channel gain setting unit adapted to set a channel gain ratio for each of a plurality of base station channels, the channel gain ratio being a ratio of transmission power of a base station channel to maximum transmission power of a base station, the base station manager further comprising a channel gain converting unit adapted to calculate a power value for each of the plurality of base station channels based on the corresponding channel gain ratio and to transmit the calculated power value to the base station; and
the base station adapted to control the transmission power of each of the plurality of base station channels based on the calculated power values.

2. The transmission power control apparatus of claim 1, wherein a first channel gain ratio is set, the first channel gain ratio being a ratio of the transmission power of a pilot channel to the maximum transmission power of the base station, wherein offset values for determining transmission powers of remaining channels of the plurality of base station channels are set in relationship to the transmission power of the pilot channel by the base station manager, and wherein the offset values for determining the transmission powers of the remaining channels are used to control the transmission powers of the remaining channels by the base station manager.

3. The transmission power control apparatus of claim 2, wherein the plurality of base station channels comprises a sync channel, a paging channel, and a traffic channel.

4. The transmission power control apparatus of claim 3, wherein the pilot channel, the sync channel and the paging channel are overhead channels.

5. The transmission power control apparatus of claim 1, wherein the base station manager further comprises:
a sector gain setting unit adapted to set a sector gain of the base station and to transmit the set sector gain to the base station; and
an RF gain setting unit adapted to set an RF gain of the base station and to transmit the set RF gain to the base station.

6. The transmission power control apparatus of claim 4, wherein the channel gain setting unit sets an offset value for determining transmission power of the sync channel in relationship to the transmission power of the pilot channel.

7. The transmission power control apparatus of claim 4, wherein the channel gain setting unit sets an offset value for determining transmission power of the paging channel in relationship to the transmission power of the pilot channel.

8. The transmission power control apparatus of claim 4, wherein the channel gain setting unit sets an offset value for determining transmission power of the traffic channel in relationship to the transmission power of the pilot channel.

9. A method for controlling transmission power of a base station in a mobile communication system, the method comprising:
setting a channel gain ratio for each of a plurality of base station channels, the channel gain ratio being a ratio of transmission power of a base station channel to maximum transmission power of the base station;
calculating power values for each of the plurality of base station channels based on the corresponding channel gain ratios; and
transmitting the calculated power values to the base station for control of the transmission power of the plurality of base station channels.

10. The method of claim 9, further comprising:
setting a first channel gain ratio, the first channel gain ratio being a ratio of the transmission power of a pilot channel to the maximum transmission power of the base station;
setting offset values for determining transmission powers of remaining channels of the base station channels in relationship to the transmission power of the pilot channel; and
controlling the transmission powers of the remaining channels using the offset values.

11. The method of claim 10, wherein the plurality of base station channels comprises a sync channel, a paging channel, and a traffic channel.

12. The method of claim 11, wherein the pilot channel, the sync channel and the paging channel are overhead channels.

13. The method of claim 9, further comprising:
setting a sector gain of the base station;
transmitting the set sector gain to the base station;
setting an RF gain of the base station; and
transmitting the set RF gain to the base station.

14. The method of claim 12, further comprising setting an offset value for determining transmission power of the sync channel in relationship to the transmission power of the pilot channel.

15. The method of claim 12, further comprising setting an offset value for determining transmission power of the paging channel in relationship to the transmission power of the pilot channel.

16. The method of claim 12, further comprising setting an offset value for determining transmission power of the traffic channel in relationship to the transmission power of the pilot channel.
